(19) United States
(12) Patent Application Publication
(10) Pub. No.: US 2022/0306116 A1
(43) Pub. Date: Sep. 29, 2022

(54) VEHICLE CONTROL DEVICE, MEDIUM FOR STORING COMPUTER PROGRAM FOR VEHICLE CONTROL, AND METHOD FOR CONTROLLING VEHICLE

(71) Applicant: TOYOTA JIDOSHA KABUSHIKI KAISHA, Toyota-shi (JP)

(72) Inventors: Ryuta HASHIMOTO, Toshima-ku (JP); Takahiro SETA, Yokohama-shi (JP); Takahiro KAWANO, Edogawa-ku (JP); Kota HARADA, Suginami-ku (JP); Yuki MORI, Ota-ku (JP)

(21) Appl. No.: 17/656,570

(22) Filed: Mar. 25, 2022

(30) Foreign Application Priority Data
Mar. 26, 2021 (JP) 2021-053546

(51) Int. Cl. B60W 30/18; B60W 60/00

(52) U.S. Cl. CPC B60W 30/18163; B60W 60/0053; B60W 2552/10; B60W 2552/53

(57) ABSTRACT

A vehicle control device has a processor configured to identify a lane merging terrain to be a predetermined terrain, and when a lane merging terrain has been identified in a predetermined driving zone of a navigation route, to set an area between a marking line disappearing point and a location such that the sum of the first distance and second distance is a first reference distance from the marking line disappearing point in the traveling direction of the vehicle, as a movement prohibited zone where movement of the vehicle between lanes by automatic control is prohibited and to generate a traveling lane plan representing a traveling lane in which the vehicle is to travel in the predetermined driving zone of the navigation route, the processor being further configured to select a traveling lane so that the vehicle does not move between lanes in the movement prohibited zone.

### FIELD

The present disclosure relates to a vehicle control device, to a medium storing a computer program for vehicle control, and to a method for controlling a vehicle.

### BACKGROUND

An automatic control system mounted in a vehicle creates a navigation route for the vehicle based on the current location of the vehicle, the destination location of the vehicle, and a navigation map. The automatic control system estimates the current location of the vehicle using the map information and controls the vehicle to travel along the navigation route.

The automatic control system also controls the vehicle to move between lanes depending on the navigation route or surrounding conditions. For movement between lanes, the automatic control system operates the vehicle so that a spacing of at least a predetermined distance is maintained between the vehicle and other vehicles.

For example, a lane change support device has been proposed which places multiple restriction levels for lane change restrictions with different reasons on each traffic lane of the road, and controls vehicle lane changes by referring to the lane change restriction levels in a vehicle navigation route (see Japanese Unexamined Patent Publication No. 2018-197758). The lane change support device controls lane changes for the vehicle so that lane changes are not recommended on terrain that merges with other roads.

### SUMMARY

Traffic lanes on a road may increase or decrease in number. For example, there may be a decrease in the number of multiple traffic lanes that were adjacent to one side of the traveling lane on which the vehicle is traveling. When a branching road with multiple lanes branches from the traveling road, there may be an increase in the number of adjacent lanes on the branching road side of the traveling lane.

When the automatic control system has caused the vehicle to move to an adjacent lane in terrain where the number of adjacent lanes to the traveling lane decreases or increases, it may become impossible to maintain a spacing of at least a predetermined distance between the vehicle and other vehicles, such that vehicle safety is no longer maintained.

It is therefore an object of the present disclosure to provide a vehicle control device that can maintain vehicle driving safety by automatic control even when it has identified terrain where it may not be possible to maintain a spacing of at least a predetermined distance between the vehicle and other vehicles when moving between lanes by automatic control.

One embodiment of the invention provides a vehicle control device. The vehicle control device has a terrain identifying unit that identifies a lane merging terrain to be terrain which has a first traffic lane marked by a common lane marking line and a first lane marking line, a second traffic lane marked by the common lane marking line and a second lane marking line, a third traffic lane marked from the second traffic lane by the second lane marking line, and a fourth traffic lane extending from a marking line disappearing point where the common lane marking line disappears in the traveling direction of the vehicle after merging between the first traffic lane and second traffic lane, and marked by the first lane marking line and second lane marking line, and wherein a first distance between the first lane marking line and an extended marking line virtually extending the common lane marking line from the marking line disappearing point in the traveling direction of the vehicle, and a second distance between the extended marking line and the second lane marking line, decrease in the traveling direction of the vehicle, based on map information; a movement prohibited zone setting unit that sets an area between the marking line disappearing point and a location from the marking line disappearing point in the traveling direction of the vehicle where the sum of the first distance and second distance is a first reference distance, as a movement prohibited zone where movement of the vehicle between lanes by automatic control is prohibited, when the lane merging terrain has been identified by the terrain identifying unit in a predetermined driving zone of a navigation route; and a traveling lane planning unit that generates a traveling lane plan representing a traveling lane in which the vehicle is to travel in the predetermined driving zone of the navigation route, based on the current location of the vehicle, the navigation route and the map information, and selects the traveling lane so that the vehicle does not move between lanes in the movement prohibited zone.

The vehicle control device also preferably has a lane change planning unit that plans movement of the vehicle between lanes based on surrounding environment information; and a control transfer zone setting unit that sets an area between the marking line disappearing point and a location from the marking line disappearing point in the traveling direction of the vehicle where the sum of the first distance and second distance is a second reference distance which is less than the first reference distance, as a control transfer request zone in which the driver is to be given a request to transfer driving of the vehicle from automatic control to manual control, when movement of the vehicle between lanes in the movement prohibited zone has been planned by the lane change planning unit.

The vehicle control device preferably further has a lane change planning unit that plans movement of the vehicle between lanes based on surrounding environment information; and a manual lane change schedule zone setting unit that sets the area between the marking line disappearing point and a location at a third distance before the marking line disappearing point, as a manual lane change schedule zone in which the driver is to be given a request to move between lanes by manual control, when movement of the vehicle between lanes in the movement prohibited zone has been planned by the lane change planning unit.

In the vehicle control device, preferably the terrain identifying unit notifies the movement prohibited zone setting unit of the length of the identified lane merging terrain, and the movement prohibited zone setting unit does not set the movement prohibited zone when the length of the identified lane merging terrain is above a threshold distance longer than the first reference distance.

Another embodiment of the invention provides a vehicle control device. The vehicle control device has a terrain identifying unit that identifies a lane branching terrain to be terrain which has a first traffic lane and a second traffic lane marked by a common lane marking line, wherein a branching road having a third traffic lane connected to the first traffic lane and a fourth traffic lane adjacent to the third traffic lane extends from a branching start location of the common lane marking line, and wherein the fourth traffic lane and second traffic lane are marked by the common lane marking line extending beyond the branching start location in the traveling direction of the vehicle, based on map information; a movement prohibited zone setting unit that sets an area between the branching start location and a location at a first distance from the branching start location in the traveling direction of the vehicle, as a movement prohibited zone where movement of the vehicle between lanes by automatic control is prohibited, when the lane branching terrain has been identified by the terrain identifying unit in a predetermined driving zone of the navigation route; and a traveling lane planning unit that generates a traveling lane plan representing a traveling lane in which the vehicle is to travel in the predetermined driving zone of the navigation route, based on the current location of the vehicle, the navigation route and the map information, and that selects the traveling lane so that the vehicle does not move between lanes in the movement prohibited zone.

The vehicle control device also preferably has a lane change planning unit that plans movement of the vehicle between lanes based on surrounding environment information; and a control transfer zone setting unit that sets an area between the branching start location and a location at a second distance that is greater than the first distance from the branching start location in the traveling direction of the vehicle, as a control transfer request zone in which the driver is to be given a request to transfer driving of the vehicle from automatic control to manual control, when movement of the vehicle between lanes in the movement prohibited zone has been planned by the lane change planning unit.

The vehicle control device preferably further has a lane change planning unit that plans movement of the vehicle between lanes based on surrounding environment information; and a manual lane change schedule zone setting unit that sets an area between the branching start location and a location at a third distance before the branching start location, as a manual lane change schedule zone in which the driver is to be given a request to move between lanes by manual control, when movement of the vehicle between lanes in the movement prohibited zone has been planned by the lane change planning unit.

In the vehicle control device, preferably the terrain identifying unit notifies the movement prohibited zone setting unit of the length of the identified lane branching terrain, and the movement prohibited zone setting unit does not set the movement prohibited zone when the length of the identified lane branching terrain is above a threshold distance longer than the first distance.

Yet another embodiment of the invention provides a vehicle control device. The vehicle control device has a terrain identifying unit that identifies a lane merging terrain to be an area which has a first traffic lane, a second traffic lane adjacent to the first traffic lane and a third traffic lane adjacent to the second traffic lane, and is between a first location where the width of the second traffic lane begins to decrease and a second location where the second traffic lane disappears and the first traffic lane and third traffic lane begin to be adjacent, based on map information; a movement prohibited zone setting unit that sets an area between the first location and a location at a first distance before the second location, as a movement prohibited zone where movement of the vehicle between lanes by automatic control is prohibited, when the lane merging terrain has been identified by the terrain identifying unit in a predetermined driving zone of the navigation route; and a traveling lane planning unit that generates a traveling lane plan representing a traveling lane in which the vehicle is to travel in the predetermined driving zone of the navigation route, based on the current location of the vehicle, the navigation route and the map information, and that selects a traveling lane so that the vehicle does not move between lanes in the movement prohibited zone.

The vehicle control device also preferably has a lane change planning unit that plans movement of the vehicle between lanes based on surrounding environment information, and a control transfer zone setting unit that sets an area between the first location and a location at a second distance that is less than the first distance before the second location, as a control transfer request zone in which the driver is to be given a request to transfer driving of the vehicle from automatic control to manual control, when movement of the vehicle between lanes in the movement prohibited zone has been planned by the lane change planning unit.

The vehicle control device preferably further has a lane change planning unit that plans movement of the vehicle between lanes based on surrounding environment information, and a manual lane change schedule zone setting unit that sets an area between the first location and a location at a third distance before the first location, as a manual lane change schedule zone in which the driver is to be given a request to move between lanes by manual control, when movement of the vehicle between lanes in the movement prohibited zone has been planned by the lane change planning unit.

In the vehicle control device, preferably the terrain identifying unit notifies the movement prohibited zone setting unit of the length of the identified lane merging terrain, and the movement prohibited zone setting unit does not set the movement prohibited zone when the length of the identified lane merging terrain is above a threshold distance longer than the first distance.

According to another embodiment, a non-transitory storage medium storing a computer program for vehicle control is provided. The computer program for vehicle control causes a processor to execute a process, the process including identifying a lane merging terrain to be terrain which has a first traffic lane marked by a common lane marking line and a first lane marking line, a second traffic lane marked by the common lane marking line and a second lane marking line, a third traffic lane marked from the second traffic lane by the second lane marking line, and a fourth traffic lane extending from a marking line disappearing point where the common lane marking line disappears in the traveling direction of the vehicle after merging between the first traffic lane and second traffic lane, and marked by the first lane marking line and second lane marking line, and wherein a first distance between the first lane marking line and an extended marking line virtually extending the common lane marking line from the marking line disappearing point in the traveling direction of the vehicle, and a second distance between the extended marking line and the second lane marking line, decrease in the traveling direction of the vehicle, based on map information; setting an area between the marking line disappearing point and a location from the marking line disappearing point in the traveling direction of the vehicle where the sum of the first distance and second distance is a first reference distance, as a movement prohibited zone where movement of the vehicle between lanes by automatic control is prohibited, when a lane merging terrain has been identified in a predetermined driving zone of a navigation route; and generating a traveling lane plan representing a traveling lane in which the vehicle is to travel in the predetermined driving zone of the navigation route, based on the current location of the vehicle, the navigation route and the map information, and wherein the process further comprising selecting the traveling lane so that the vehicle does not move between lanes in the movement prohibited zone.

According to another embodiment, a non-transitory storage medium storing a computer program for vehicle control is provided. The computer program for vehicle control causes a processor to execute a process, the process including identifying a lane branching terrain to be terrain which has a first traffic lane and a second traffic lane marked by a common lane marking line, wherein a branching road having a third traffic lane connected to the first traffic lane and a fourth traffic lane adjacent to the third traffic lane extends from a branching start location of the common lane marking line, and wherein the fourth traffic lane and second traffic lane are marked by the common lane marking line extending beyond the branching start location in the traveling direction of the vehicle, based on map information; setting an area between the branching start location and a location at a first distance from the branching start location in the traveling direction of the vehicle, as a movement prohibited zone where movement of the vehicle between lanes by automatic control is prohibited, when the lane branching terrain has been identified in a predetermined driving zone of a navigation route; and generating a traveling lane plan representing a traveling lane in which the vehicle is to travel in the predetermined driving zone of the navigation route, based on the current location of the vehicle, the navigation route and the map information, and wherein the traveling lane is selected so that the vehicle does not move between lanes in the movement prohibited zone.

According to another embodiment, a non-transitory storage medium storing a computer program for vehicle control is provided. The computer program for vehicle control causes a processor to execute a process, the process including identifying a lane merging terrain to be an area which has a first traffic lane, a second traffic lane adjacent to the first traffic lane and a third traffic lane adjacent to the second traffic lane, and is between a first location where the width of the second traffic lane begins to decrease and a second location where the second traffic lane disappears and the first traffic lane and third traffic lane begin to be adjacent, based on map information; setting an area between the first location and a location at a first distance before the second location as a movement prohibited zone where movement of the vehicle between lanes by automatic control is prohibited, when the lane merging terrain has been identified in a predetermined driving zone of a navigation route; and generating a traveling lane plan representing a traveling lane in which the vehicle is to travel in the predetermined driving zone of the navigation route, based on the current location of the vehicle, the navigation route and the map information, and wherein the traveling lane is selected so that the vehicle does not move between lanes in the movement prohibited zone.

Yet another embodiment of the invention provides a method for controlling a vehicle carried out by a vehicle control device. The method for controlling a vehicle includes identifying a lane merging terrain to be terrain which has a first traffic lane marked by a common lane marking line and a first lane marking line, a second traffic lane marked by the common lane marking line and a second lane marking line, a third traffic lane marked from the second traffic lane by the second lane marking line, and a fourth traffic lane extending from a marking line disappearing point where the common lane marking line disappears in the traveling direction of the vehicle after merging between the first traffic lane and second traffic lane, and marked by the first lane marking line and second lane marking line, and wherein a first distance between the first lane marking line and an extended marking line virtually extending the common lane marking line from the marking line disappearing point in the traveling direction of the vehicle, and a second distance between the extended marking line and the second lane marking line, decrease in the traveling direction of the vehicle, based on map information; setting an area between the marking line disappearing point and a location from the marking line disappearing point in the traveling direction of the vehicle where the sum of the first distance and second distance is a first reference distance, as a movement prohibited zone where movement of the vehicle between lanes by automatic control is prohibited, when a lane merging terrain has been identified in a predetermined driving zone of a navigation route; and generating a traveling lane plan representing a traveling lane in which the vehicle is to travel in the predetermined driving zone of the navigation route, based on the current location of the vehicle, the navigation route and the map information, and wherein the traveling lane is selected so that the vehicle does not move between lanes in the movement prohibited zone.

Yet another embodiment of the invention provides a method for controlling a vehicle carried out by a vehicle control device. The method for controlling a vehicle includes identifying a lane branching terrain to be terrain which has a first traffic lane and a second traffic lane marked by a common lane marking line, wherein a branching road having a third traffic lane connected to the first traffic lane and a fourth traffic lane adjacent to the third traffic lane extends from a branching start location of the common lane marking line, and wherein the fourth traffic lane and second traffic lane are marked by the common lane marking line extending beyond the branching start location in the traveling direction of the vehicle, based on map information; setting an area between the branching start location and a location at a first distance from the branching start location in the traveling direction of the vehicle, as a movement prohibited zone where movement of the vehicle between lanes by automatic control is prohibited, when the lane branching terrain has been identified in a predetermined driving zone of a navigation route; and generating a traveling lane plan representing a traveling lane in which the vehicle is to travel in the predetermined driving zone of the navigation route, based on the current location of the vehicle, the navigation route and the map information, and wherein the traveling lane is selected so that the vehicle does not move between lanes in the movement prohibited zone.

Yet another embodiment of the invention provides a method for controlling a vehicle carried out by a vehicle control device. The method for controlling a vehicle includes identifying a lane merging terrain to be an area which has a first traffic lane, a second traffic lane adjacent to the first traffic lane and a third traffic lane adjacent to the second traffic lane, and is between a first location where the width of the second traffic lane begins to decrease and a second location where the second traffic lane disappears and the first traffic lane and third traffic lane begin to be adjacent, based on map information; setting an area between the first location and a location at a first distance before the second location as a movement prohibited zone where movement of the vehicle between lanes by automatic control is prohibited, when the lane merging terrain has been identified in a predetermined driving zone of a navigation route; and generating a traveling lane plan representing a traveling lane in which the vehicle is to travel in the predetermined driving zone of the navigation route, based on the current location of the vehicle, the navigation route and the map information, and wherein the traveling lane is selected so that the vehicle does not move between lanes in the movement prohibited zone.

Since the vehicle control device of the present disclosure prohibits movement of the vehicle from the traveling lane by automatic control when it has identified terrain where it may not be possible to maintain a spacing of at least a predetermined distance between the vehicle and other vehicles when moving between lanes by automatic control, it is able to maintain vehicle driving safety by automatic control.

The object and advantages of the invention will be realized and attained by means of the elements and combinations particularly pointed out in the claims. It is to be understood that both the foregoing general description and the following detailed description are exemplary and explanatory and are not restrictive of the invention, as claimed

### BRIEF DESCRIPTION OF DRAWINGS

FIG. 1 is a diagram illustrating in overview the operation of a vehicle control system according to a first embodiment.

FIG. 2 is a general schematic drawing of a vehicle in which the vehicle control system of the first embodiment is mounted.

FIG. 3 is an example of an operation flow chart for vehicle control processing by the vehicle control system of the first embodiment.

FIG. 4 is an example of an operation flow chart for vehicle control processing when a lane change has been generated for a movement prohibited zone.

FIG. 5 is a diagram illustrating an example of vehicle control processing in a vehicle control system according to the first embodiment.

FIG. 6 is a diagram illustrating in overview the operation of a vehicle control system according to a second embodiment.

FIG. 7 is a diagram illustrating an example of vehicle control processing in a vehicle control system according to the second embodiment.

FIG. 8 is a diagram illustrating in overview the operation of a vehicle control system according to a third embodiment.

FIG. 9 is a diagram illustrating an example of vehicle control processing in a vehicle control system according to the third embodiment.

### DESCRIPTION OF EMBODIMENTS

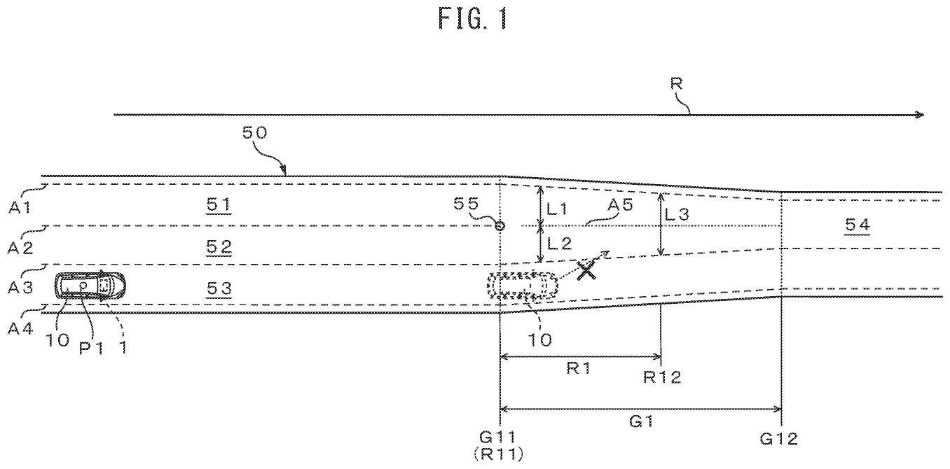

FIG. 1 is a diagram illustrating in overview the operation of a vehicle control system 1 according to the first embodiment. Operation relating to vehicle control processing by the vehicle control system 1 disclosed herein will now be described in overview with reference to FIG. 1.

The vehicle 10 is traveling on one traffic lane 53 of a road 50 having traffic lanes 51, 52, 53. The traffic lane 51 is marked by a lane marking line A1 and a lane marking line A2, the traffic lane 52 is marked by the lane marking line A2 and a lane marking line A3, and the traffic lane 53 is marked by the lane marking line A3 and a lane marking line A4. A navigation route R generated by the vehicle control system 1 represents progress of the vehicle 10 along the road 50.

Based on map information, the vehicle control system 1 identifies a predetermined lane merging terrain G1 within the nearest driving zone of a navigation route R. In the lane merging terrain G1, the traffic lane 51 and traffic lane 52 marked by the lane marking line A2, which is a common lane marking line, merge from a marking line disappearing point 55 where the lane marking line A2 disappears, forming a traffic lane 54 that extends in the traveling direction of the vehicle 10. In the lane merging terrain G1, the distance L1 between the lane marking line A1 and an extended marking line A5 which virtually extends the lane marking line A2 in the traveling direction of the vehicle 10 from the marking line disappearing point 55, and the distance L2 between the extended marking line A5 and the lane marking line A3, both decrease in the traveling direction of the vehicle 10.

Since the traffic lane 51 and traffic lane 52 decrease in width in the same manner ahead from the marking line disappearing point 55 in the lane merging terrain G1, the traffic lane 54 does not appear to extend with either the traffic lane 51 or traffic lane 52 as the main lane. Therefore, drivers of other vehicles traveling on the traffic lane 51 or traffic lane 52 may travel on the traffic lane 54 with the sense that the traffic lane 51 or traffic lane 52 on which they have been traveling continues forward.

Drivers of other vehicles that have approached by traveling on the traffic lane 51 or traffic lane 52 in the lane merging terrain G1 may potentially fail to pay adequate attention to the vehicle 10 that is moving from the traffic lane 53 to the traffic lane 54. This is especially possible for drivers of other vehicles that have approached by traveling on the traffic lane 51. In the lane merging terrain G1, therefore, the vehicle 10 may not be able to keep a safe distance from other vehicles when it is attempted to move from the traffic lane 53 to the traffic lane 54 while maintaining safe distance from other vehicles by automatic control.

The vehicle control system 1 therefore sets the area between the marking line disappearing point 55 and a location R12 from the marking line disappearing point 55 in the traveling direction of the vehicle 10 where the sum of the distance L1 and distance L2 is a first reference distance L3, to be a movement prohibited zone R1 where movement of the vehicle 10 between lanes by automatic control is prohibited.

Based on the current location P1 of the vehicle 10, the navigation route R and map information, the vehicle control system 1 generates a traveling lane plan representing the traveling lane in which the vehicle 10 is to travel within the nearest driving zone of the navigation route R. The vehicle control system 1 selects a traveling lane so that the vehicle 10 does not move between lanes within the movement prohibited zone R1 of the lane merging terrain G1.

Since the vehicle control system 1 prohibits movement of the vehicle 10 from the traveling lane by automatic control when it has identified lane merging terrain G1 where it may not be possible to maintain a spacing of at least a predetermined distance between the vehicle 10 and other vehicles when moving between lanes by automatic control, it is able to maintain safe driving of the vehicle 10 by automatic control.

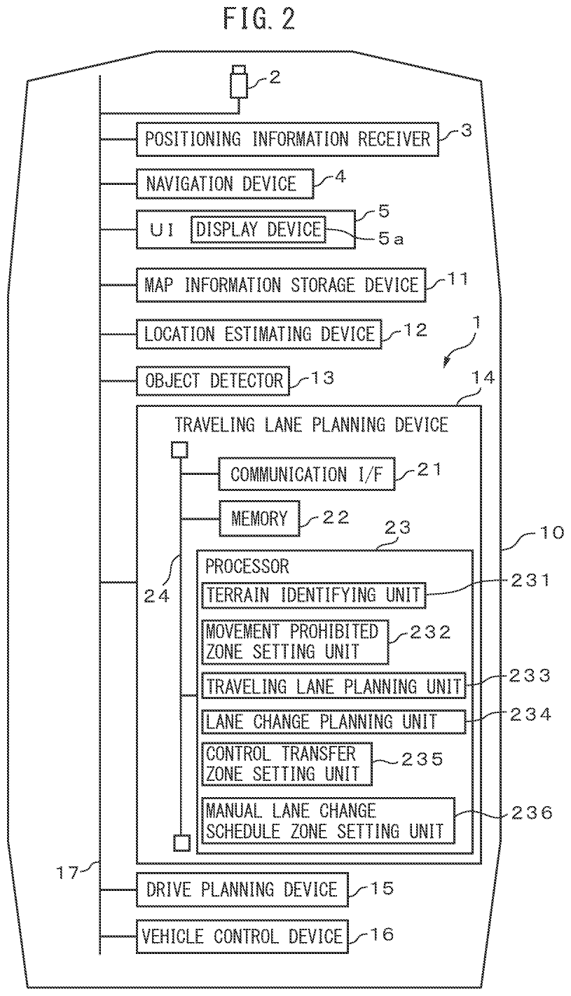

FIG. 2 is a general schematic drawing of a vehicle 10 in which the vehicle control system 1 is mounted. The vehicle 10 has a camera 2, a positioning information receiver 3, a navigation device 4, a user interface (UI) 5, a map information storage device 11, a location estimating device 12, an object detector 13, a traveling lane planning device 14, a drive planning device 15 and a vehicle control device 16. The vehicle 10 may also have a LiDAR sensor, as a distance sensor (not shown) for measurement of the distance of the vehicle 10 to surrounding objects.

The camera 2, positioning information receiver 3, navigation device 4, UI 5, map information storage device 11, location estimating device 12, object detector 13, traveling lane planning device 14, drive planning device 15 and vehicle control device 16 are connected in a communicable manner through an in-vehicle network 17 that conforms to controller area network standards.

The camera 2 is an example of an imaging unit provided in the vehicle 10. The camera 2 is mounted inside the vehicle 10 and directed toward the front of the vehicle 10. The camera 2, for example, takes a camera image in which the environment of a predetermined region ahead of the vehicle 10 is shown, at a predetermined cycle. The camera image can show the road in the predetermined region ahead of the vehicle 10, and road features such as surface lane marking lines on the road. The camera 2 has a 2D detector composed of an array of photoelectric conversion elements with visible light sensitivity, such as a CCD or C-MOS, and an imaging optical system that forms an image of the photographed region on the 2D detector.

Each time a camera image is taken, the camera 2 outputs the camera image and the camera image photograph time at which the camera image was taken, through the in-vehicle network 17 to the location estimating device 12 and object detector 13 etc. The camera image is also used for processing at the location estimating device 12 to estimate the location of the vehicle 10. At the object detector 13, the camera image is used for processing to detect other objects surrounding the vehicle 10.

The positioning information receiver 3 outputs positioning information that represents the current location of the vehicle 10. The positioning information receiver 3 may be a GNSS receiver, for example. The positioning information receiver 3 outputs positioning information and the positioning information acquisition time at which the positioning information has been acquired, to the navigation device 4 and map information storage device 11 etc., each time positioning information is acquired at a predetermined receiving cycle.

Based on the navigation map information, the destination location of the vehicle 10 input through the UI 5, and positioning information representing the current location of the vehicle 10 input from the positioning information receiver 3, the navigation device 4 creates a navigation route R from the current location to the destination location of the vehicle 10. The navigation route R includes information relating to the locations of right turns, left turns, merging and branching. When the destination location has been newly set or the current location of the vehicle 10 has exited the navigation route R, the navigation device 4 creates a new navigation route R for the vehicle 10. Every time a navigation route R is created, the navigation device 4 outputs the navigation route R to the location estimating device 12 and the traveling lane planning device 14 etc., via the in-vehicle network 17.

The UI 5 is an example of the notifying unit. The UI 5, controlled by the navigation device 4 and vehicle control device 16, notifies the driver of the vehicle 10 traveling information, and of control transfer requests whereby the driver is requested to transfer driving of the vehicle 10 from automatic control to manual control, or requests for lane change by manual control. The UI 5 also creates an operation signal in response to operation of the vehicle 10 by the driver. The traveling information of the vehicle 10 includes information relating to the current location of the vehicle and the current and future route of the vehicle, such as the navigation route. The UI 5 has a display device 5a such as a liquid crystal display or touch panel, for display of the traveling information. The UI 5 may also have an acoustic output device (not shown) to notify the driver of traveling information. The UI 5 also has a touch panel or operating button, for example, as an input device for inputting operation information from the driver to the vehicle 10. The operation information may be, for example, a destination location, transit points, vehicle speed, control transfer request acknowledgement, or other control information for vehicles 10. The UI 5 outputs the input operation information to the navigation device 4 and the vehicle control device 16, via the in-vehicle network 17.

The map information storage device 11 stores wide-area map information for a relatively wide area (an area of 10 km² to 30 km², for example) that includes the current location of the vehicle 10. The map information preferably has high precision map information including three-dimensional information for the road surface, information for the types and locations of structures and road features such as road lane marking lines, and the legal speed limit for the road. The traveling lane planning device 14 is able to identify terrain such as the lane merging terrain G1 mentioned above based on map information. The map information may also be associated with locations on a terrain such as the lane merging terrain G1, and it may include identifying information for identification of the terrain.

The map information storage device 11 receives the wide-area map information from an external server via a base station, by wireless communication through a wireless communication device (not shown) mounted in the vehicle 10, in relation to the current location of the vehicle 10, and stores it in the storage device. Each time positioning information is input from the positioning information receiver 3, the map information storage device 11 refers to the stored wide-area map information and outputs map information for a relatively narrow area including the current location represented by the positioning information (for example, an area of 100 m² to 10 km²), through the in-vehicle network 17 to the location estimating device 12, object detector 13, traveling lane planning device 14, drive planning device 15 and vehicle control device 16 etc.

The location estimating device 12 estimates the location of the vehicle 10 at the camera image photograph time, based on the road features surrounding the vehicle 10 represented in the camera image. For example, the location estimating device 12 compares lane marking lines identified in the camera image with lane marking lines represented in the map information input from the map information storage device 11, and determines the estimated location and estimated declination of the vehicle 10 at the camera image photograph time. The location estimating device 12 estimates the road traveling lane where the vehicle 10 is located, based on the lane marking lines represented in the map information and on the estimated location and estimated declination of the vehicle 10. Each time the estimated location, estimated declination and traveling lane of the vehicle 10 are determined at the camera image photograph time, the location estimating device 12 outputs this information to the object detector 13, traveling lane planning device 14, drive planning device 15 and vehicle control device 16 etc.

The object detector 13 detects other objects around the vehicle 10 and their types (for example, vehicles) based on the camera image, for example. Other objects also include other vehicles traveling around the vehicle 10. The object detector 13 tracks other detected objects and determines the trajectories of the other objects. In addition, the object detector 13 identifies the traveling lanes in which the other objects are traveling, based on the lane marking lines represented in the map information and the locations of the objects. The object detector 13 outputs object detection information which includes information representing the types of other objects that were detected, information indicating their locations, and also information indicating their traveling lanes, to the traveling lane planning device 14 and drive planning device 15 etc.

At a traveling lane-planning creation time set in a predetermined cycle, the traveling lane planning device 14 selects a traffic lane on the road on which the vehicle 10 is traveling, within the nearest driving zone (for example, 10 km) selected from the navigation route R, based on the map information, the navigation route R and surrounding environment information and the current location of the vehicle 10, and creates a traveling lane plan representing the scheduled traveling lane for traveling of the vehicle 10. For example, the traveling lane planning device 14 creates a traveling lane plan for the vehicle 10 to travel on a traffic lane other than a passing traffic lane. The traveling lane planning device 14 selects a traveling lane so that the vehicle 10 does not move between lanes within the movement prohibited zone R1 of the lane merging terrain G1. Each time a traveling lane plan is created, the traveling lane planning device 14 outputs the drive planning device 15 of the traveling lane plan. The traveling lane planning device 14 is an example of the vehicle control device.

The traveling lane planning device 14 also determines whether or not a lane change is necessary within the nearest driving zone selected from the navigation route R, based on the traveling lane plan, the map information, the navigation route R and the current location of the vehicle 10, and generates a lane change plan in accordance with the assessment results. Specifically, the traveling lane planning device 14 determines whether or not a lane change is necessary for moving to a traffic lane toward the destination location of the vehicle 10, based on the navigation route R and the current location of the vehicle 10. It is determined whether or not the vehicle 10 is approaching another road that merges ahead from the traveling road on which it is currently traveling (merge), or the vehicle 10 is exiting onto another road branching out ahead from the traveling road (branch). Since merging and branching involve movement of the vehicle from a lane of the traveling road to a lane in another road, a lane change is carried out. The traveling lane planning device 14 may further utilize surrounding environment information or vehicle status information to determine whether or not a lane change is necessary. The surrounding environment information includes the locations and speeds of other vehicles traveling around the vehicle 10. The vehicle status information includes the current location of the vehicle 10, and the vehicle speed, acceleration and traveling direction. The traveling lane planning device 14 may also generate lane change plans in response to requests for movement between lanes by the driver. When a lane change plan has been generated, the traveling lane planning device 14 outputs the traveling lane plan with the added lane change plan to the drive planning device 15.

The traveling lane planning device 14 also identifies lane merging terrains. The traveling lane planning device 14 sets the area of the lane merging terrain between the marking line disappearing point and a location from the marking line disappearing point in the traveling direction of the vehicle 10 where the sum of the distance L1 and distance L2 is a first reference distance L3, to be a movement prohibited zone where movement of the vehicle 10 between lanes by automatic control is prohibited. Based on a request by the driver or surrounding environment information, when movement of the vehicle 10 between lanes in a movement prohibited zone has been planned, the traveling lane planning device 14 sets the area between the marking line disappearing point and a location from the marking line disappearing point in the traveling direction of the vehicle 10 where the sum of the distance L1 and distance L2 is a second reference distance which is less than the first reference distance L3, as a control transfer request zone in which the driver is to be given a request to transfer driving of the vehicle 10 from automatic control to manual control. The traveling lane planning device 14 also sets an area between the marking line disappearing point and a location at a predetermined distance before the marking line disappearing point, as a manual lane change schedule zone in which the driver is to be given a request to move between lanes by manual control. The traveling lane planning device 14 comprises a communication interface (IF) 21, a memory 22 and a processor 23 for this purpose. The communication interface 21, memory 22 and processor 23 are connected via signal wires 24. The communication interface 21 has an interface circuit to connect the traveling lane planning device 14 with the in-vehicle network 17.

All or some of the functions of the traveling lane planning device 14 are functional modules driven by a computer program operating on the processor 23, for example. The processor 23 has a terrain identifying unit 231, a movement prohibited zone setting unit 232, a traveling lane planning unit 233, a lane change planning unit 234, a control transfer zone setting unit 235 and a manual lane change schedule zone setting unit 236. Alternatively, the functional module of the processor 23 may be a specialized computing circuit in the processor 23. The processor 23 comprises one or more CPUs (Central Processing Units) and their peripheral circuits. The processor 23 may also have other computing circuits such as a logical operation unit, numerical calculation unit or graphic processing unit. The memory 22 is an example of a memory unit, and it has a volatile semiconductor memory and a non-volatile semiconductor memory, for example. The memory 22 stores an application computer program and various data to be used for information processing carried out by the processor 23 of each device. The traveling lane planning unit 233 generates the aforementioned traveling lane plan while the lane change planning unit 234 generates the aforementioned lane change plan. Other details regarding operation of the traveling lane planning device 14 are described below.

At a driving plan creation time set with a predetermined cycle, the drive planning device 15 carries out driving plan processing in which it creates a driving plan representing the scheduled traveling trajectory of the vehicle 10 up until a predetermined time (for example, 5 seconds), based on the traveling lane plan, the map information, the current location of the vehicle 10, the surrounding environment information and the vehicle status information. The driving plan is represented as a combination of the target location of the vehicle 10 and the target vehicle speed at the target location, at each time from the current time until the predetermined time. The cycle in which the driving plan is created is preferably shorter than the cycle in which the traveling lane plan is created. The drive planning device 15 generates a driving plan to maintain a spacing of at least a predetermined distance between the vehicle 10 and other vehicles. When the traveling lane plan includes a lane change wherein the vehicle 10 is to move between lanes, but a spacing of at least a predetermined distance cannot be ensured between the vehicle 10 and another vehicle, the drive planning device 15 generates a driving plan for stopping the vehicle 10. The drive planning device 15 outputs the driving plan to the vehicle control device 16 for each driving plan generated.

When the vehicle 10 is operated by automatic control, the vehicle control device 16 controls each unit of the vehicle 10 based on the current location of the vehicle 10 and the vehicle speed and yaw rate, as well as on the driving plan generated by the drive planning device 15. For example, the vehicle control device 16 determines the steering angle, acceleration and angular acceleration of the vehicle 10 according to the driving plan and the speed and yaw rate of the vehicle 10, and sets the amount of steering, and the accelerator or brake level so as to match that steering angle, accelerator level and angular acceleration. The vehicle control device 16 also outputs a control signal corresponding to a set steering amount, to an actuator (not shown) that controls the steering wheel for the vehicle 10, via the in-vehicle network 17. The vehicle control device 16 also determines the amount of fuel injection according to a set accelerator level, and outputs a control signal corresponding to the amount of fuel injection to a drive unit (not shown) of the engine of the vehicle 10, via the in-vehicle network 17. Alternatively, the vehicle control device 16 may output a control signal corresponding to a set brake level to the brake (not shown) of the vehicle 10, via the in-vehicle network 17. When the vehicle 10 is operated by manual control, the vehicle control device 16 controls the steering wheel, drive unit or brake according to the amount of driver-operated steering, accelerator or brake level.

For FIG. 2, the map information storage device 11, location estimating device 12, object detector 13, traveling lane planning device 14, drive planning device 15 and vehicle control device 16 were explained as separate devices, but all or some of them may be constructed in a single device.

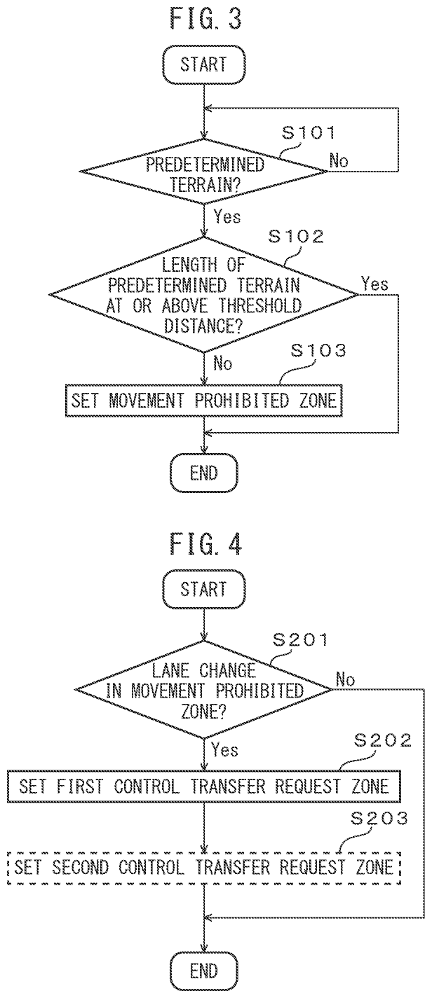

FIG. 3 is an example of an operation flow chart for vehicle control processing by the vehicle control system 1 of the first embodiment. Vehicle control processing by the vehicle control system 1 will be described below with reference to FIG. 3. The traveling lane planning device 14 carries out terrain identification processing according to the operation flow chart shown in FIG. 3, at a terrain identification time having a predetermined cycle. The cycle in which the terrain identification processing is carried out is preferably shorter than the cycle in which the traveling lane plan is created.

First, the terrain identifying unit 231 refers to map information, and determines whether or not a lane merging terrain G1, as an example of a predetermined terrain, exists within the nearest driving zone of a navigation route R (step S101). When a lane merging terrain G1 does not exist (step S101—No), the terrain identifying unit 231 waits until the next terrain identification time and then proceeds to execute step S101. When a lane merging terrain G1 exists (step S101—Yes), the terrain identifying unit 231 determines whether or not the length of the lane merging terrain G1 is above a threshold distance (step S102).

When the length of the lane merging terrain G1 is less than the threshold distance (step S102—No), the movement prohibited zone setting unit 232 sets the area between the marking line disappearing point 55 and a location R12 from the marking line disappearing point 55 in the traveling direction of the vehicle 10 where the sum of the distance L1 and distance L2 is a first reference distance L3 to be the movement prohibited zone R1 where movement of the vehicle 10 between lanes by automatic control is prohibited (step S103), thus completing the series of steps.

When the length of the lane merging terrain G1 is at or above the threshold distance (step S102—Yes), the series of steps is complete.

Processing by the traveling lane planning device 14 in the operation flow chart shown in FIG. 3 will now be explained based on the example of FIG. 1. At each terrain identification time, the terrain identifying unit 231 refers to the map information stored in the map information storage device 11 and determines whether or not a lane merging terrain exists within the nearest driving zone of the navigation route R.

Referring to the map information, the terrain identifying unit 231 determines whether or not a terrain exists that has a first traffic lane marked by a common lane marking line and a first lane marking line, a second traffic lane marked by the common lane marking line and a second lane marking line, a third traffic lane marked from the second traffic lane by the second lane marking line, and a fourth traffic lane with a marking line disappearing point where the common lane marking line disappears and the first lane and second lane merge from the marking line disappearing point and extend in the traveling direction of the vehicle, and marked by the first lane marking line and second lane marking line, and wherein a first distance between the first lane marking line and an extended marking line virtually extending the common lane marking line from the marking line disappearing point in the traveling direction of the vehicle and a second distance between the extended marking line and the second lane marking line, both decrease in the traveling direction of the vehicle. When it has been determined that such a terrain exists, the terrain identifying unit 231 identifies the lane merging terrain G1 from the terrains included in the map information.

The terrain identifying unit 231 refers to the map information and determines that the lane merging terrain G1 exists. The lane merging terrain G1 has a traffic lane 51 marked by the lane marking line A2, which is a common lane marking line, and the lane marking line A1, a traffic lane 52 marked by the lane marking line A2 and the lane marking line A3, a traffic lane 53 marked from the traffic lane 52 by the lane marking line A3, and a traffic lane 54 marked by the lane marking line A1 and the lane marking line A3, where the traffic lane 51 and traffic lane 52 merge from the marking line disappearing point 55 where the lane marking line A2 disappears, and extend in the traveling direction of the vehicle 10. In the lane merging terrain G1, the distance L1 between the lane marking line A1 and an extended marking line A5 which virtually extends the lane marking line A2 in the traveling direction of the vehicle 10 from the marking line disappearing point 55, and the distance L2 between the extended marking line A5 and the lane marking line A3, both decrease in the traveling direction of the vehicle 10.

The terrain identifying unit 231 may also refer to the map information to determine whether or not a lane merging terrain G1 exists within the nearest driving zone of the navigation route R, which is identified by predetermined identification information.

The terrain identifying unit 231 may also use an identifier that has learned to identify the lane merging terrain G1, for identification of the lane merging terrain G1 within the nearest driving zone of the navigation route R based on map information.

In the example shown in FIG. 1, the start location G1l of the lane merging terrain G1 matches the marking line disappearing point 55 in the direction in which the road 50 extends. In addition, the end location G12 of the lane merging terrain G1 matches the start location where the sum of distance L1 and distance L2 is constant in the direction in which the road 50 extends. A constant sum of distance L1 and distance L2 includes variation of the sum of distance L1 and distance L2 within a predetermined value. The terrain identifying unit 231 refers to the map information and calculates the length of the lane merging terrain G1. The length of the lane merging terrain G1 is, for example, the length along the center line of the road 50 between the start location G1l and the end location G12. The terrain identifying unit 231 notifies the movement prohibited zone setting unit 232 of the length of the identified lane merging terrain G1.

The movement prohibited zone setting unit 232 therefore sets the area between the marking line disappearing point 55 and a location R12 from the marking line disappearing point 55 in the traveling direction of the vehicle 10 where the sum of the distance L1 and distance L2 is a first reference distance L3, to be a movement prohibited zone R1 where movement of the vehicle 10 between lanes by automatic control is prohibited. The start location R11 of the movement prohibited zone R1 matches the marking line disappearing point 55 in the direction in which the road 50 extends. The movement prohibited zone R1 is the zone of the lane merging terrain G1 between the start location R11 and the end location R12. The traveling direction of the vehicle 10 matches the direction in which the road 50 extends.

The first reference distance L3 preferably corresponds to the location where the width of the traffic lane 54 decreases to about a single lane width. When the width of the traffic lane 54 decreases to about a single lane width, drivers of other vehicles that have approached by traveling on the traffic lane 51 or traffic lane 52 may be expected to pay adequate attention to the vehicle 10 that is moving from the traffic lane 53 to the traffic lane 54. For example, the first reference distance L3 may be in a range of 1.0 to 1.5 times the width of the traffic lane 51 or traffic lane 52.

When the length of the lane merging terrain G1 is less than a predetermined distance, the movement prohibited zone setting unit 232 may set the movement prohibited zone R1 to be across the entire lane merging terrain G1.

In the movement prohibited zone R1, the vehicle 10 is prohibited from moving from the traffic lane 53 to the traffic lane 54 by automatic control. In the movement prohibited zone R1, the vehicle 10 is also prohibited from moving from the traffic lane 54 to the traffic lane 53 by automatic control. The traveling lane planning unit 233 selects a traveling lane and generates a traveling lane plan so that the vehicle 10 does not move between lanes in the movement prohibited zone R1. In the example shown in FIG. 1, the traveling lane planning unit 233 selects the traffic lane 53 as the lane in which the vehicle 10 is to travel in the lane merging terrain G1.

When the length of the lane merging terrain G1 is at or above the threshold distance, however, the movement prohibited zone setting unit 232 does not set the movement prohibited zone for the lane merging terrain G1. A sufficiently long lane merging terrain G1 can ensure adequate time to allow control of the vehicle 10 operation in response to movement of other vehicles. This means that the vehicle can maintain a spacing of at least a predetermined distance between the vehicle 10 and other vehicles when the vehicle 10 moves between lanes by automatic control. The threshold distance is determined based on the product of the most recent average speed of the vehicle 10 and a predetermined time, for example. The predetermined time may be 5 to 15 seconds, for example.

FIG. 4 is an example of an operation flow chart for a vehicle control system of the first embodiment, where a lane change has been planned in a movement prohibited zone. The lane planning device 14 carries out vehicle control processing according to the operation flow chart shown in FIG. 4, each time a new lane change plan is generated. The operation flow chart shown in FIG. 4 is not carried out, however, when the movement prohibited zone is not set for the lane merging terrain.

First, when the lane change plan has been generated, the control transfer zone setting unit 235 determines whether or not movement of the vehicle 10 between lanes in the movement prohibited zone has been planned (step S201). Although a lane change is not planned in the movement prohibited zone based on the traveling lane plan, a lane change may potentially be planned based on surrounding environment information or a request for movement between lanes by the driver. Movement of the vehicle 10 between lanes in the movement prohibited zone means that there is overlap in the lane change plan between the zone where a lane change of the vehicle 10 is scheduled and the movement prohibited zone.

When movement of the vehicle 10 between lanes in the movement prohibited zone has been planned (step S201—Yes), the control transfer zone setting unit 235 sets an area in the lane merging terrain G1 between the marking line disappearing point and a location from the marking line disappearing point in the traveling direction of the vehicle 10 where the sum of the distance L1 and distance L2 is a second reference distance which is less than the first reference distance L3, as a first control transfer request zone in which the driver is to be given a request to transfer driving of the vehicle 10 from automatic control to manual control (step S202), thus completing the series of steps.

When movement of the vehicle between lanes in a movement prohibited zone has not been planned (step S201—No), the series of steps is complete.

In the operation flow chart shown in FIG. 4, the processing of step S203 may be carried out instead of step S202. In this case, the control transfer zone setting unit 235 sets the area between the marking line disappearing point and a location at a predetermined distance before the marking line disappearing point as the second control transfer request zone where the driver is to be requested to transfer driving of the vehicle 10 from automatic control to manual control (step S204), and the series of steps is complete.

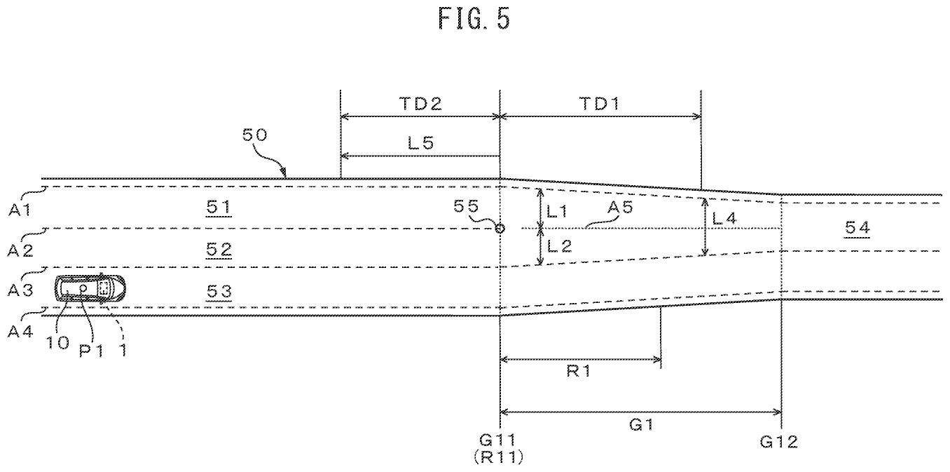

Processing by the traveling lane planning device 14 in the operation flow chart shown in FIG. 4 will now be explained based on the example of FIG. 5. FIG. 5 is a diagram illustrating an example of vehicle control processing in a vehicle control system according to the first embodiment. When movement of the vehicle 10 between lanes in the movement prohibited zone R1 has been planned, the control transfer zone setting unit 235 sets an area between the marking line disappearing point 55 and a location from the marking line disappearing point 55 in the traveling direction of the vehicle 10 where the sum of the distance L1 and distance L2 is a second reference distance L4 which is less than the first reference distance L3, as a first control transfer request zone TD1 in which the driver is to be given a request to transfer driving of the vehicle 10 from automatic control to manual control. The lower limit for the second reference distance L4 may be the value when the width of the traffic lane 54 becomes constant, for example.

In the movement prohibited zone R1, movement between lanes by automatic control is prohibited from the viewpoint of maintaining safety for driving of the vehicle 10. In some cases, movement of the vehicle 10 between lanes in the movement prohibited zone R1 may be planned in order to prevent the vehicle 10 from approaching other vehicles traveling ahead of the vehicle 10.

The first control transfer request zone TD1 is therefore set in the lane merging terrain G1. When the vehicle 10 enters the first control transfer request zone TD1, the driver is notified of a control transfer request by the vehicle control device 16, via the UI 5. After the driver has carried out the operation of acknowledging the control transfer request via the UI 5 etc., driving of the vehicle 10 by manual control begins. The vehicle control device 16 notifies the driver of movement between lanes, via the UI 5. Following the notification, the driver moves between lanes within the movement prohibited zone R1. After the vehicle 10 has passed through the first control transfer request zone TD1, the driver may continue driving of the vehicle 10 by manual control, or may change to driving of the vehicle 10 by automatic control.

The location of the second reference distance L4 is preferably set so that the length of the first control transfer request zone TD1 is sufficient to give the driver notified of the control transfer request ample time to acknowledge the control transfer request and begin driving of the vehicle 10.

When the length of the lane merging terrain G1 is less than the predetermined distance, the first control transfer request zone TD1 may be set across the entire lane merging terrain G1.

When step S203 has been carried out instead of step S202, the control transfer zone setting unit 235 sets the area between the marking line disappearing point 55 and a location at distance L5 before the marking line disappearing point 55 as the second control transfer request zone TD2 where the driver is to be requested to transfer driving of the vehicle 10 from automatic control to manual control.

The distance L5 is preferably set so that the length of the second control transfer request zone TD2 is sufficient to give the driver notified of the control transfer request ample time to acknowledge the control transfer request and begin driving of the vehicle 10. The distance L5 is determined based on the most recent average speed of the vehicle 10, for example.

When movement of the vehicle 10 between lanes in the movement prohibited zone R1 has been planned, the second control transfer request zone TD2 in which the driver is to be requested to transfer driving of the vehicle 10 from automatic control to manual control is set before the vehicle 10 enters the movement prohibited zone R1. This allows the driver to be given ample time to begin driving of the vehicle 10 by manual control to move between lanes in the movement prohibited zone R1.

The manual lane change schedule zone setting unit 236 may also set a manual lane change schedule zone in which the driver is to be given a request to move between lanes by manual control, instead of the first control transfer request zone TD1 or second control transfer request zone TD2. In this case, when the vehicle 10 enters into the manual lane change schedule zone, the driver is notified of a request to move between lanes by manual control by the vehicle control device 16, via the UI 5. In the manual lane change schedule zone, driving of the vehicle 10 is in an automatic control state, and the vehicle control device 16 controls the steering wheel, drive unit or brake according to the amount of driver-operated steering, and the accelerator or brake level. In the manual lane change schedule zone, the driver can drive the vehicle 10 by manual control to move between lanes.

Since the vehicle control device prohibits movement of the vehicle from the traveling lane by automatic control when it has identified lane merging terrain where it may not be possible to maintain a spacing of at least a predetermined distance between the vehicle and other vehicles when moving between lanes by automatic control, as explained above, it is able to maintain vehicle driving safety by automatic control.

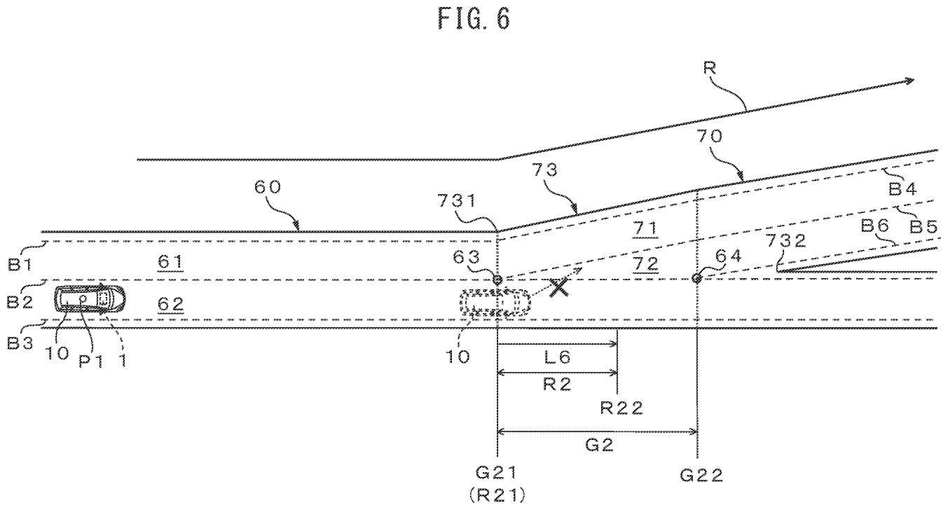

Another embodiment of the vehicle control device will now be described with reference to FIG. 6 to FIG. 13. The explanation of the first embodiment is to be applied for any aspects of this additional embodiment that are not explained here.

FIG. 6 is a diagram illustrating in overview the operation of a vehicle control system according to the second embodiment. The vehicle 10 is traveling on a traffic lane 62 of a road 60 having traffic lanes 61, 62. The traffic lane 61 is marked by a lane marking line B1 and a lane marking line B2, and the traffic lane 62 is marked by the lane marking line B2 and a lane marking line B3. The navigation route R generated by the vehicle control system 1 represents exiting of the vehicle 10 from the road 60 onto a branching road 70 at a road branching location 73.

The branching road 70 has traffic lanes 71, 72. The traffic lane 71 is marked by a lane marking line B4 and a lane marking line B5, and the traffic lane 72 is marked by the lane marking line B5 and a lane marking line B6. At the road branching location 73, the road 60 and branching road 70 are connected between a road branching start location 731 and a road branching end location 732.

Based on map information, the vehicle control system 1 identifies a predetermined lane branching terrain G2 within the nearest driving zone of the navigation route R. The lane branching terrain G2 has a traffic lane 61 and a traffic lane 62 marked by a lane marking line B2, which is a common lane marking line, with a branching road 70, being a branching road having a traffic lane 71 connected to the traffic lane 61 and a traffic lane 72 adjacent to the traffic lane 71, extending from the branching start location 63 of the lane marking line B2, wherein the traffic lane 72 and traffic lane 62 are marked by the lane marking line B2 which extends beyond the branching start location 63 in the traveling direction of the vehicle 10.

The lane marking line B5 extends from the branching start location 63. The lane marking line B6 extends from the road branching end location 64. The traffic lane 72 of the branching road 70 is marked by the lane marking line B5 and lane marking line B6, and is a new lane emerging from the branching start location 63.

Vehicles approaching on the traffic lane 61 and vehicles approaching on the traffic lane 62 can move onto the traffic lane 72 after having passed the branching start location 63. Drivers of other vehicles that have approached the traffic lane 61 may also move their vehicles onto the traffic lane 72 after having entered the traffic lane 71. However, drivers of other vehicles that have approached by traveling on the traffic lane 61 may potentially fail to pay adequate attention to the vehicle 10 that is moving from the traffic lane 62 to the traffic lane 72. In the lane branching terrain G2, therefore, the vehicle 10 may not be able to keep a safe distance from other vehicles when it is attempted to move from the traffic lane 62 to the traffic lane 72 while maintaining safe distance from other vehicles by automatic control.

The vehicle control system 1 therefore sets the area between the branching start location 63 and a location at distance L6 from the branching start location 63 in the traveling direction of the vehicle 10, to be a movement prohibited zone R2 where movement of the vehicle 10 between lanes by automatic control is prohibited.

Based on the current location P1 of the vehicle, the navigation route R, map information and surrounding environment information, the vehicle control system 1 generates a traveling lane plan representing the traveling lane in which the vehicle 10 is to travel within the nearest driving zone of the navigation route R. The vehicle control system 1 selects a traveling lane so that the vehicle 10 does not move between lanes in the movement prohibited zone R2.

Since the vehicle control system 1 prohibits movement of the vehicle from the traveling lane by automatic control when it has identified a lane branching terrain G2 where it may not be possible to maintain a spacing of at least a predetermined distance between the vehicle 10 and other vehicles when moving between lanes by automatic control, it is able to maintain safe driving of the vehicle 10 by automatic control.

Vehicle control processing by the vehicle control system 1 of this embodiment will now be described with reference to FIG. 3. The traveling lane planning device 14 carries out terrain identification processing according to the operation flow chart shown in FIG. 3, at a terrain identification time having a predetermined cycle.

First, the terrain identifying unit 231 refers to map information, and determines whether or not a lane branching terrain G2, as an example of a predetermined terrain, exists within the nearest driving zone of a navigation route R (step S101). When a lane branching terrain G2 does not exist (step S101—No), the terrain identifying unit 231 waits until the next terrain identification time and then proceeds to execute step S101. When a lane branching terrain G2 exists (step S101—Yes), the terrain identifying unit 231 determines whether or not the length of the lane branching terrain G2 is above a threshold distance (step S102).

When the length of the lane branching terrain G2 is less than the threshold distance (step S102—No), the movement prohibited zone setting unit 232 sets the area between the branching start location, and a location at a predetermined distance from the branching start location in the traveling direction of the vehicle 10, to be a movement prohibited zone R2 where movement of the vehicle 10 between lanes by automatic control is prohibited (step S103), thus completing the series of steps.

When the length of the lane branching terrain G2 is at or above the threshold distance (step S102—Yes), the series of steps is complete.

Processing by the traveling lane planning device 14 of the vehicle control system for this embodiment according to the operation flow chart shown in FIG. 3 will now be explained based on FIG. 6. At each terrain identification time, the terrain identifying unit 231 refers to the map information stored in the map information storage device 11 and determines whether or not a lane branching terrain exists within the nearest driving zone of the navigation route R.

The terrain identifying unit 231 refers to the map information, and determines whether or not a terrain exists that has a first traffic lane and a second traffic lane marked by a common lane marking line, with a branching road having a third traffic lane connected to the first traffic lane and a fourth traffic lane adjacent to the third traffic lane, extending from the branching start location of the common lane marking line, and with the fourth traffic lane and second traffic lane marked by a common lane marking line extending beyond the branching start location in the traveling direction of the vehicle 10. When it has been determined that such a terrain exists, the terrain identifying unit 231 identifies the lane branching terrain G2 from the terrains included in the map information.

The terrain identifying unit 231 refers to the map information and determines that the lane branching terrain G2 exists. The lane branching terrain G2 has a traffic lane 61 and a traffic lane 62 marked by a lane marking line B2, which is a common lane marking line, with a branching road 70, being a branching road with a traffic lane 71 connected to the traffic lane 61 and a traffic lane 72 adjacent to the traffic lane 71, extending from the branching start location 63 of the lane marking line B2, wherein the traffic lane 72 and traffic lane 62 are marked by the lane marking line B2 which extends beyond the branching start location 63 in the traveling direction of the vehicle 10.

The map information may also be associated with locations on the lane branching terrain G2, and it may include identifying information for identification of the lane branching terrain G2. The terrain identifying unit 231 may also refer to the map information to determine whether or not a lane branching terrain G2 exists within the nearest driving zone of the navigation route R, which is identified by predetermined identification information.

The terrain identifying unit 231 may also use an identifier that has learned to identify the lane branching terrain G2, for identification of the lane branching terrain G2 within the nearest driving zone of the navigation route R based on map information.

In the example shown in FIG. 6, the start location G21 of the lane branching terrain G2 matches the branching start location 63 in the direction in which the road 60 extends. The end location G22 of the lane branching terrain G2 also matches the location 64 where the lane marking line B6 branches from the lane marking line B2 in the direction in which the road 60 extends. The terrain identifying unit 231 refers to the map information and calculates the length of the lane branching terrain G2. The length of the lane branching terrain G2 is, for example, the length along the center line of the road 60 between the start location G21 and the end location G22. The terrain identifying unit 231 notifies the movement prohibited zone setting unit 232 of the length of the identified lane branching terrain G2. The end location G22 of the lane branching terrain G2 may also match the road branching end location 732.

The movement prohibited zone setting unit 232 sets the area between the branching start location 63 of the lane marking line B2 and a location R22 at distance L6 from the branching start location 63 in the traveling direction of the vehicle 10, to be a movement prohibited zone R2 where movement of the vehicle 10 between lanes by automatic control is prohibited. The start location R21 of the movement prohibited zone R2 matches the branching start location 63 in the direction in which the road 60 extends. The movement prohibited zone R2 is the zone of the lane branching terrain G2 between the start location R21 and the end location R22.

The distance L6 is a distance such that any distance further than distance L6 from the branching start location 63 allows safe distance between the vehicle 10 and other vehicles to be maintained by controlling steering or the speed of the vehicle 10 based on surrounding environment information, when the vehicle 10 moves between lanes by automatic control. The distance L6 is determined based on the most recent average speed of the vehicle 10, for example. When the length of the lane branching terrain G2 is less than distance L6, the movement prohibited zone R2 is set to be across the entire lane branching terrain G2.

In the movement prohibited zone R2, the vehicle 10 is prohibited from moving from the traffic lane 62 to the traffic lane 72 by automatic control. In the movement prohibited zone R2, the vehicle 10 is also prohibited from moving from the traffic lane 71 to the traffic lane 72 by automatic control. The traveling lane planning unit 233 selects a traveling lane and generates a traveling lane plan so that the vehicle 10 does not move between lanes in the movement prohibited zone R2.

When the length of the lane branching terrain G2 is at or above the threshold distance, however, the movement prohibited zone setting unit 232 does not set the movement prohibited zone for the lane branching terrain G2. A sufficiently long lane branching terrain G2 can ensure adequate time to allow control of the vehicle 10 operation in response to movement of other vehicles. This means that the vehicle can maintain a spacing of at least a predetermined distance between the vehicle 10 and other vehicles when the vehicle 10 moves between lanes by automatic control. The threshold distance is determined based on the product of the most recent average speed of the vehicle 10 and a predetermined time, for example. The predetermined time may be 5 to 15 seconds, for example.

Operation in the vehicle control system of the second embodiment when a lane change has been planned in the movement prohibited zone will now be explained with reference to FIG. 4. The lane planning device 14 carries out vehicle control processing according to the operation flow chart shown in FIG. 4, each time a new lane change plan is generated. The operation flow chart shown in FIG. 4 is not carried out, however, when the movement prohibited zone is not set for the lane branching terrain.

First, when the lane change plan has been generated, the control transfer zone setting unit 235 determines whether or not movement of the vehicle between lanes in the movement prohibited zone has been planned (step S201). Although a lane change is not planned in the movement prohibited zone based on the traveling lane plan, a lane change may potentially be planned based on surrounding environment information or a request for movement between lanes by the driver.

When movement of the vehicle between lanes in the movement prohibited zone has been planned (step S201—Yes), the control transfer zone setting unit 235 sets an area in the lane branching terrain G2 between the branching start location and a location at a predetermined distance of at least distance L6 from the branching start location in the traveling direction of the vehicle 10, as a first control transfer request zone in which the driver is to be given a request to transfer driving of the vehicle 10 from automatic control to manual control (step S202), thus completing the series of steps.

When movement of the vehicle between lanes in a movement prohibited zone has not been planned (step S201—No), the series of steps is complete.

In the operation flow chart shown in FIG. 4, the processing of step S203 may be carried out instead of step S202. In this case, the control transfer zone setting unit 235 sets the area between the branching start location and a location at a predetermined distance before the branching start location as the second control transfer request zone where the driver is to be requested to transfer driving of the vehicle 10 from automatic control to manual control (step S203), and the series of steps is complete.

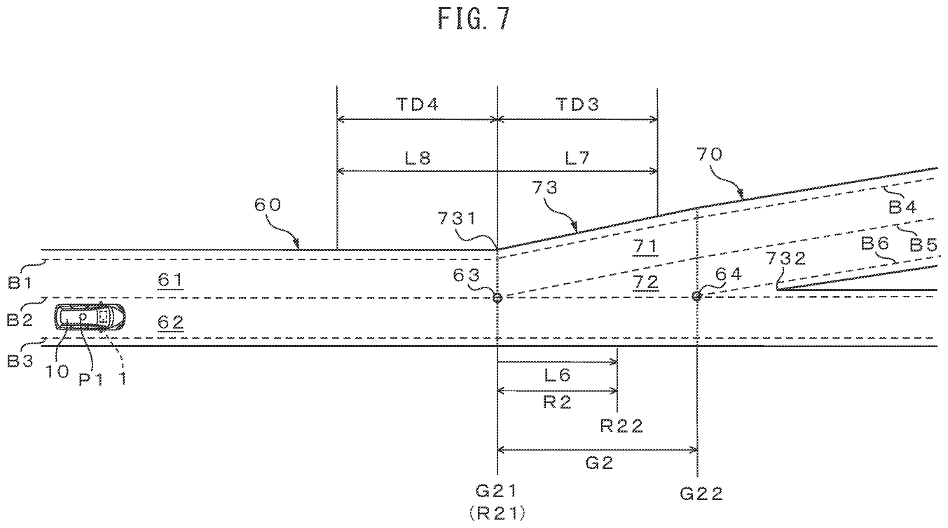

Processing by the traveling lane planning device 14 in the operation flow chart shown in FIG. 4 will now be explained based on the example of FIG. 7. FIG. 7 is a diagram illustrating an example of vehicle control processing in a vehicle control system according to the embodiment. When movement of the vehicle 10 between lanes in the movement prohibited zone R2 has been planned, the control transfer zone setting unit 235 sets an area between the branching start location 63 and a location at a distance L7 which is greater than the distance L6 from the branching start location 63 in the traveling direction of the vehicle 10, as a first control transfer request zone TD3 in which the driver is to be given a request to transfer driving of the vehicle 10 from automatic control to manual control. In the example shown in FIG. 7, the distance L7 is a distance along the center line of the road 60, but it may instead be a distance along the center line of the road 70.

In the movement prohibited zone R2, movement between lanes by automatic control is prohibited from the viewpoint of maintaining safety for driving of the vehicle 10. In some cases, movement of the vehicle 10 between lanes in the movement prohibited zone R2 may be planned in order to prevent the vehicle 10 from approaching other vehicles traveling ahead of the vehicle 10.

The first control transfer request zone TD3 is therefore set in the lane branching terrain G2. When the vehicle 10 enters the first control transfer request zone TD3, the driver is notified of a control transfer request by the vehicle control device 16, via the UI 5. After the driver has carried out the operation of acknowledging the control transfer request via the UI 5 etc., driving of the vehicle 10 by manual control begins. The vehicle control device 16 notifies the driver of movement between lanes, via the UI 5. Following the notification, the driver moves between lanes within the movement prohibited zone R2. After the vehicle 10 has passed through the first control transfer request zone TD3, the driver may continue driving of the vehicle 10 by manual control, or may change to driving of the vehicle 10 by automatic control.

The distance L7 is preferably set so that the length of the first control transfer request zone TD3 is sufficient to give the driver notified of the control transfer request ample time to acknowledge the control transfer request and begin driving of the vehicle 10.

When the length of the lane branching terrain G2 is less than distance L7, the first control transfer request zone TD3 may be set to be across the entire lane branching terrain G2. The distance L7 is determined based on the most recent average speed of the vehicle 10, for example.

When step S203 has been carried out instead of step S202, the control transfer zone setting unit 235 sets the area between the branching start location 63 and a location at distance L8 from the branching start location 63 as the second control transfer request zone TD4 where the driver is to be requested to transfer driving of the vehicle 10 from automatic control to manual control.

The distance L8 is preferably set so that the length of the second control transfer request zone TD4 is sufficient to give the driver notified of the control transfer request ample time to acknowledge the control transfer request and begin driving of the vehicle 10. The distance L8 is determined based on the most recent average speed of the vehicle 10, for example.

When movement of the vehicle 10 between lanes in the movement prohibited zone R2 has been planned, the second control transfer request zone TD4 in which the driver is to be requested to transfer driving of the vehicle 10 from automatic control to manual control is set before the vehicle 10 enters the movement prohibited zone R2. This allows the driver to be given ample time to begin driving of the vehicle 10 by manual control to move between lanes in the movement prohibited zone R2.

The manual lane change schedule zone setting unit 236 may also set a manual lane change schedule zone in which the driver is to be notified of a request to move between lanes by manual control by the vehicle control device 16, by way of the UI 5, instead of the first control transfer request zone TD3 or second control transfer request zone TD4. In the manual lane change schedule zone, driving of the vehicle 10 is in an automatic control state, and the vehicle control device 16 controls the steering wheel, drive unit or brake according to the amount of driver-operated steering, and the accelerator or brake level. In the manual lane change schedule zone, the driver can drive the vehicle 10 by manual control to move between lanes.

Since the vehicle control device prohibits movement of the vehicle from the traveling lane by automatic control when a lane branching terrain has been identified where it may not be possible to maintain a spacing of at least a predetermined distance between the vehicle and other vehicles when moving between lanes by automatic control, as explained above, it is able to maintain vehicle driving safety by automatic control.

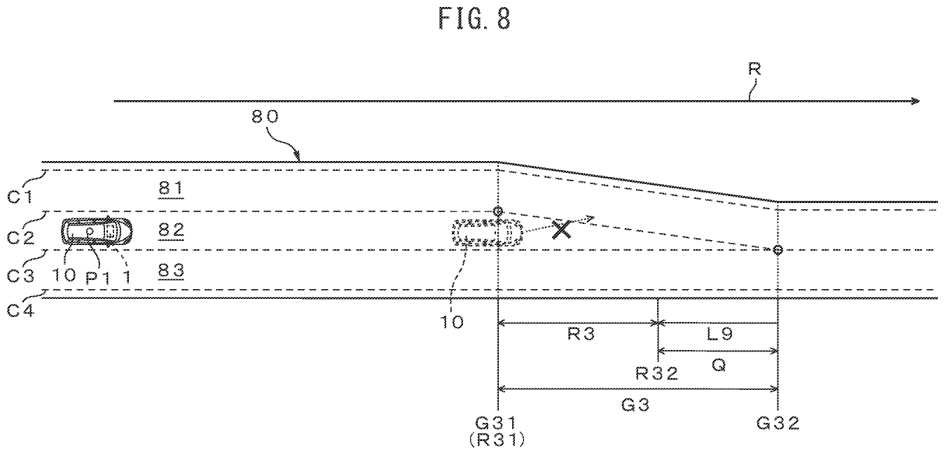

FIG. 8 is a diagram illustrating in overview the operation of a vehicle control system according to the third embodiment. The vehicle 10 is traveling on a traffic lane 82 of a road 80 having traffic lanes 81, 82, 83. The traffic lane 81 is marked by a lane marking line C1 and a lane marking line C2, the traffic lane 82 is marked by the lane marking line C2 and a lane marking line C3, and the traffic lane 83 is marked by the lane marking line C3 and a lane marking line C4. A navigation route R generated by the vehicle control system 1 represents progress of the vehicle 10 along the road 80.

Based on map information, the vehicle control system 1 identifies a predetermined lane merging terrain G3 within the nearest driving zone of a navigation route R. The lane merging terrain G3 has a traffic lane 81, a traffic lane 82 adjacent to the traffic lane 81 and a traffic lane 83 adjacent to the traffic lane 82, and also has a first location G31 where the width of the traffic lane 82 begins to decrease and a second location G32 where the traffic lane 82 disappears and the traffic lane 81 and traffic lane 83 begin to be adjacent.

The traffic lane 82 disappears in the lane merging terrain G3, but the traffic lane 81 and traffic lane 83 do not decrease in width. The vehicle 10 traveling on the traffic lane 82 attempts to move to either the traffic lane 81 or the traffic lane 83 in the lane merging terrain G3, but drivers of other vehicles approaching on the traffic lane 81 or traffic lane 83 may fail to pay adequate attention to the vehicle 10 that is attempting to move between lanes from the traffic lane 82, because the widths of the lanes in which their vehicles are traveling do not change. In the lane merging terrain G3, therefore, the vehicle 10 may not be able to keep a safe distance from other vehicles when it is attempted to move from the traffic lane 82 to the traffic lane 81 or traffic lane 83 while maintaining safe distance from other vehicles by automatic control.

The vehicle control system 1 therefore sets the area between the first location G31 and a location R32 at a distance L9 before the second location G32, as a movement prohibited zone R3 where movement of the vehicle 10 between lanes by automatic control is prohibited.

Based on the current location P1 of the vehicle, the navigation route R, map information and surrounding environment information, the vehicle control system 1 generates a traveling lane plan representing the traveling lane in which the vehicle 10 is to travel within the nearest driving zone of the navigation route R. The vehicle control system 1 selects a traveling lane so that the vehicle 10 does not move between lanes in the movement prohibited zone R3.

Since the vehicle control system 1 prohibits movement of the vehicle from the traveling lane by automatic control when it has identified a lane merging terrain G3 where it may not be possible to maintain a spacing of at least a predetermined distance between the vehicle 10 and other vehicles when moving between lanes by automatic control, it is able to maintain safe driving of the vehicle 10 by automatic control.

Vehicle control processing by the vehicle control system 1 of this embodiment will now be described with reference to FIG. 3. The traveling lane planning device 14 carries out terrain identification processing according to the operation flow chart shown in FIG. 3, at a terrain identification time having a predetermined cycle.

First, the terrain identifying unit 231 refers to map information, and determines whether or not a lane merging terrain G3, as an example of a predetermined terrain, exists within the nearest driving zone of a navigation route R (step S101). When a lane merging terrain G3 does not exist (step S101—No), the terrain identifying unit 231 waits until the next terrain identification time and then proceeds to execute step S101. When a lane merging terrain G3 exists (step S101—Yes), the terrain identifying unit 231 determines whether or not the length of the lane merging terrain G3 is above a threshold distance (step S102).

When the length of the lane merging terrain G3 is less than the threshold distance (step S102—No), the movement prohibited zone setting unit 232 sets the area between the first location G31 and the location at a predetermined distance before the second location G32, to be the movement prohibited zone R3 where movement of the vehicle 10 between lanes by automatic control is prohibited (step S103), thus completing the series of steps.

When the length of the lane merging terrain G3 is at or above the threshold distance (step S102—Yes), the series of steps is complete.

Processing by the traveling lane planning device 14 of the vehicle control system for this embodiment according to the operation flow chart shown in FIG. 3 will now be explained based on FIG. 8. At each terrain identification time, the terrain identifying unit 231 refers to the map information stored in the map information storage device 11 and determines whether or not a lane branching terrain exists within the nearest driving zone of the navigation route R.

The terrain identifying unit 231 refers to the map information and determines whether or not a terrain exists having a first traffic lane, a second traffic lane adjacent to the first traffic lane and a third traffic lane adjacent to the second traffic lane, and including a first location where the width of the second traffic lane begins to decrease and a second location where the second traffic lane disappears and the first traffic lane and third traffic lane begin to be adjacent. When it has been determined that such a terrain exists, the terrain identifying unit 231 identifies the lane merging terrain G3 from the terrains included in the map information.

The terrain identifying unit 231 refers to the map information and determines that the lane merging terrain G3 exists. The lane merging terrain G3 has a traffic lane 81, a traffic lane 82 adjacent to the traffic lane 81 and a traffic lane 83 adjacent to the traffic lane 82, and also has a first location G31 where the width of the traffic lane 82 begins to decrease and a second location G32 where the traffic lane 82 disappears and the traffic lane 81 and third traffic lane 83 begin to be adjacent.

The map information may also be associated with locations on the lane merging terrain G3, and it may include identifying information for identification of the lane merging terrain G3. The terrain identifying unit 231 may also refer to the map information to determine whether or not a lane merging terrain G3 exists within the nearest driving zone of the navigation route R, which is identified by predetermined identification information.

The terrain identifying unit 231 may also use an identifier that has learned to identify the lane merging terrain G3, for identification of the lane merging terrain G3 within the nearest driving zone of the navigation route R based on map information.

In the example shown in FIG. 8, the first location G31 and second location G32 represent locations in the direction in which the road 80 extends. The start location of the lane merging terrain G3 matches the first location G31 in the direction in which the road 80 extends. The end location of the lane merging terrain G3 matches the second location G32 in the direction in which the road 80 extends. The terrain identifying unit 231 refers to the map information and calculates the length of the lane merging terrain G3. The length of the lane merging terrain G3 is, for example, the length along the center line of the road 80 between the start location G31 and the end location G32. The terrain identifying unit 231 notifies the movement prohibited zone setting unit 232 of the length of the identified lane merging terrain G3.

The movement prohibited zone setting unit 232 therefore sets the area between the start location G31 and a location R32 at a distance L9 from the end location G32, as a movement prohibited zone R3 where movement of the vehicle 10 between lanes by automatic control is prohibited. The start location R31 of the movement prohibited zone R3 matches the start location G31 in the direction in which the road 80 extends. The movement prohibited zone R3 is the zone of the lane merging terrain G3 between the start location R31 and the end location R32. The distance L9 is the distance along the center line of the road 80, for example.

The zone Q between the end location R32 of the movement prohibited zone R3 and the end location G32 of the lane merging terrain G3 is a permitted zone where movement of the vehicle 10 between lanes by automatic control is permitted. The distance L9 is set so that, while the vehicle 10 is traveling in the movement prohibited zone R3, the vehicle 10 can safely move between lanes in the permitted zone Q by control of steering or the speed of the vehicle 10 by the vehicle control system 1 based on surrounding environment information. The distance L9 is determined based on the most recent average speed of the vehicle 10, for example.

When the length of the lane merging terrain G3 is less than a predetermined distance, the movement prohibited zone setting unit 232 may set the movement prohibited zone R3 to be across the entire lane merging terrain G3. This is because from a safety standpoint it is not desirable to provide a permitted zone Q if the length of the lane merging terrain G3 is not sufficiently long.

In the movement prohibited zone R3, the vehicle 10 is prohibited from moving from the traffic lane 82 to the traffic lane 81 and the traffic lane 83 by automatic control. In the movement prohibited zone R3, the vehicle 10 is also prohibited from moving from the traffic lane 81 or the traffic lane 83 to the traffic lane 82 by automatic control. The traveling lane planning unit 233 selects a traveling lane and generates the traveling lane plan so that the vehicle 10 does not move between lanes in the movement prohibited zone R3.

When it is not possible to move from the traffic lane 82 to the traffic lane 81 and traffic lane 83 by automatic control in the permitted zone Q, the drive planning device 15 of the vehicle 10 may control the vehicle 10 so that it stops on the traffic lane 82.

When the length of the lane merging terrain G3 is above the threshold distance, however, the movement prohibited zone setting unit 232 does not set the movement prohibited zone for the lane merging terrain G3. A sufficiently long lane merging terrain G3 can ensure adequate time to allow control of the vehicle 10 operation in response to movement of other vehicles. This means that the vehicle can maintain a spacing of at least a predetermined distance between the vehicle 10 and other vehicles when the vehicle 10 moves between lanes by automatic control. The threshold distance is determined based on the product of the most recent average speed of the vehicle 10 and a predetermined time, for example. The predetermined time may be 5 to 15 seconds, for example.

Operation in the vehicle control system of the third embodiment when a lane change has been planned in the movement prohibited zone will now be explained with reference to FIG. 4. The lane planning device 14 carries out vehicle control processing according to the operation flow chart shown in FIG. 4, each time a new lane change plan is generated. The operation flow chart shown in FIG. 4 is not carried out, however, when the movement prohibited zone is not set for the lane merging terrain.

First, when the lane change plan has been generated, the control transfer zone setting unit 235 determines whether or not movement of the vehicle between lanes in the movement prohibited zone has been planned (step S201). Although a lane change is not planned in the movement prohibited zone based on the traveling lane plan, a lane change may potentially be planned based on surrounding environment information or a request for movement between lanes by the driver.

When movement of the vehicle between lanes in the movement prohibited zone has been planned (step S201—Yes), the control transfer zone setting unit 235 sets an area in the lane merging terrain G3 between the first location G31 and a location at a predetermined distance of less than the distance L9 before the second location G32, as a first control transfer request zone in which the driver is to be given a request to transfer driving of the vehicle 10 from automatic control to manual control (step S202), thus completing the series of steps.

When movement of the vehicle between lanes in a movement prohibited zone has not been planned (step S201—No), the series of steps is complete.

In the operation flow chart shown in FIG. 4, the processing of step S203 may be carried out instead of step S202. In this case, the control transfer zone setting unit 235 sets the area between the first location G31 and a location at a predetermined distance before the first location G31 as the second control transfer request zone where the driver is to be requested to transfer driving of the vehicle 10 from automatic control to manual control (step S203), and the series of steps is complete.

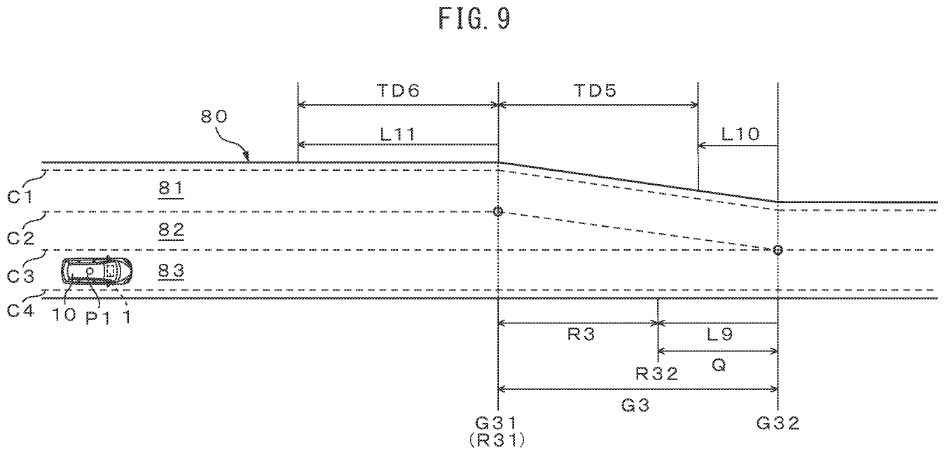

Processing by the traveling lane planning device 14 in the operation flow chart shown in FIG. 4 will now be explained based on the example of FIG. 9. FIG. 9 is a diagram illustrating an example of vehicle control processing in a vehicle control system according to the embodiment. When movement of the vehicle 10 between lanes in the movement prohibited zone R3 has been planned, the control transfer zone setting unit 235 sets an area between the first location G31 and a location at a distance L10 which is less than the distance L9 before the second location G32, as a first control transfer request zone TD5 in which the driver is to be given a request to transfer driving of the vehicle 10 from automatic control to manual control. The distance L10 is the distance along the center line of the road 80, for example.

In the movement prohibited zone R3, movement between lanes by automatic control is prohibited from the viewpoint of maintaining safety for driving of the vehicle 10. In some cases, movement of the vehicle 10 between lanes in the movement prohibited zone R3 may be planned in order to prevent the vehicle 10 from approaching other vehicles traveling ahead of the vehicle 10.

The first control transfer request zone TD5 is therefore set in the lane merging terrain G3. When the vehicle 10 enters the first control transfer request zone TD5, the driver is notified of a control transfer request by the vehicle control device 16, via the UI 5. After the driver has carried out the operation of acknowledging the control transfer request via the UI 5 etc., driving of the vehicle 10 by manual control begins. The vehicle control device 16 notifies the driver of movement between lanes, via the UI 5. Following the notification, the driver moves between lanes within the movement prohibited zone R3.

After the vehicle 10 has passed through the first control transfer request zone TD5, the driver may continue driving of the vehicle 10 by manual control, or may change to driving of the vehicle 10 by automatic control.

The distance L10 is preferably set so that the length of the first control transfer request zone TD5 is sufficient to give the driver notified of the control transfer request ample time to acknowledge the control transfer request and begin driving of the vehicle 10. The distance L10 is determined based on the most recent average speed of the vehicle 10, for example.

When the length of the lane merging terrain G3 is less than the predetermined distance, the first control transfer request zone TD5 may be set across the entire lane merging terrain G3.

When step S203 has been carried out instead of step S202, the control transfer zone setting unit 235 sets the area between the first location G31 and a location at distance L11 before the first location G31 as a second control transfer request zone TD6 where the driver is to be requested to transfer driving of the vehicle 10 from automatic control to manual control.

The distance L11 is preferably set so that the length of the first control transfer request zone TD6 is at a location sufficient to give the driver notified of the control transfer request ample time to acknowledge the control transfer request and begin driving of the vehicle 10. The distance L11 is determined based on the most recent average speed of the vehicle 10, for example.

When movement of the vehicle 10 between lanes in the movement prohibited zone R3 has been planned, the second control transfer request zone TD6 in which the driver is to be requested to transfer driving of the vehicle 10 from automatic control to manual control is set before the vehicle 10 enters the movement prohibited zone R3. This allows the driver to be given ample time to begin driving of the vehicle 10 by manual control to move between lanes in the movement prohibited zone R3.

The manual lane change schedule zone setting unit 236 may also set a manual lane change schedule zone in which the driver is to be notified of a request to move between lanes by manual control by the vehicle control device 16, by way of the UI 5, instead of the first control transfer request zone TD5 or second control transfer request zone TD6. In the manual lane change schedule zone, the driver can drive the vehicle 10 by manual control to move between lanes.

Since the vehicle control device prohibits movement of the vehicle from the traveling lane by automatic control when it has identified lane merging terrain where it may not be possible to maintain a spacing of at least a predetermined distance between the vehicle and other vehicles when moving between lanes by automatic control, as explained above, it is able to maintain vehicle driving safety by automatic control.

The vehicle control device, the medium storing a computer program for vehicle control and the method for controlling a vehicle according to the embodiment described above may incorporate appropriate modifications that are still within the gist of the disclosure. Moreover, the technical scope of the disclosure is not limited to these embodiments, and includes the invention and its equivalents as laid out in the Claims.

For example, in the embodiments described above the terrain identified by each traveling lane planning device was different, but for example, a single traveling lane planning device may identify three terrains and may set a movement prohibited zone corresponding to those terrains.

1. A vehicle control device comprising:
a processor configured to
identify a lane merging terrain to be terrain which has a first traffic lane marked by a common lane marking line and a first lane marking line, a second traffic lane marked by the common lane marking line and a second lane marking line, a third traffic lane marked from the second traffic lane by the second lane marking line, and a fourth traffic lane extending from a marking line disappearing point where the common lane marking line disappears in the traveling direction of the vehicle after merging between the first traffic lane and second traffic lane, and marked by the first lane marking line and second lane marking line, and wherein a first distance between the first lane marking line and an extended marking line virtually extending the common lane marking line from the marking line disappearing point in the traveling direction of the vehicle, and a second distance between the extended marking line and the second lane marking line, decrease in the traveling direction of the vehicle, based on map information,
set an area between the marking line disappearing point and a location from the marking line disappearing point in the traveling direction of the vehicle where the sum of the first distance and second distance is a first reference distance, as a movement prohibited zone where movement of the vehicle between lanes by automatic control is prohibited, when the lane merging terrain has been identified in a predetermined driving zone of a navigation route, and
generate a traveling lane plan representing a traveling lane in which the vehicle is to travel in the predetermined driving zone of the navigation route, based on the current location of the vehicle, the navigation route and the map information,
wherein the processor is further configured to select the traveling lane so that the vehicle does not move between lanes in the movement prohibited zone.

2. The vehicle control device according to claim 1, wherein the processor is further configured to plan movement of the vehicle between lanes based on surrounding environment information, and
the processor is further configured to set an area between the marking line disappearing point and a location from the marking line disappearing point in the traveling direction of the vehicle where the sum of the first distance and second distance is a second reference distance which is less than the first reference distance, as a control transfer request zone in which the driver is to be given a request to transfer driving of the vehicle from automatic control to manual control, when movement of the vehicle between lanes in the movement prohibited zone has been planned.

3. The vehicle control device according to claim 1, wherein the processor is further configured to plan movement of the vehicle between lanes based on surrounding environment information, and
the processor is further configured to set an area between the marking line disappearing point and a location at a third distance before the marking line disappearing point, as a manual lane change schedule zone in which the driver is to be given a request to move between lanes by manual control, when movement of the vehicle between lanes in the movement prohibited zone has been planned.

4. The vehicle control device according to claim 1, wherein the processor is further configured to not set the movement prohibited zone when the length of the identified lane merging terrain is above a threshold distance longer than the first reference distance.

5. A vehicle control device comprising:
a processor configured to
identify a lane branching terrain to be terrain which has a first traffic lane and a second traffic lane marked by a common lane marking line, wherein a branching road having a third traffic lane connected to the first traffic lane and a fourth traffic lane adjacent to the third traffic lane extends from a branching start location of the common lane marking line, and wherein the fourth traffic lane and second traffic lane are marked by the common lane marking line extending beyond the branching start location in the traveling direction of the vehicle, based on map information,
set an area between the branching start location and a location at a first distance from the branching start location in the traveling direction of the vehicle, as a movement prohibited zone where movement of the vehicle between lanes by automatic control is prohibited, when the lane branching terrain has been identified in a predetermined driving zone of a navigation route, and
generate a traveling lane plan representing a traveling lane in which the vehicle is to travel in the predetermined driving zone of the navigation route, based on the current location of the vehicle, the navigation route and the map information,
wherein the processor is further configured to select the traveling lane so that the vehicle does not move between lanes in the movement prohibited zone.

6. The vehicle control device according to claim 5, wherein the processor is further configured to plan movement of the vehicle between lanes based on surrounding environment information, and
the processor is further configured to set an area between the branching start location and a location at a second distance that is greater than the first distance from the branching start location in the traveling direction of the vehicle, as a control transfer request zone in which the driver is to be given a request to transfer driving of the vehicle from automatic control to manual control, when movement of the vehicle between lanes in the movement prohibited zone has been planned.

7. The vehicle control device according to claim 5, wherein the processor is further configured to plan movement of the vehicle between lanes based on surrounding environment information, and
the processor is further configured to set an area between the branching start location and a location at a third distance before the branching start location, as a manual lane change schedule zone in which the driver is to be given a request to move between lanes by manual control, when movement of the vehicle between lanes in the movement prohibited zone has been planned.

8. The vehicle control device according to claim 5, wherein the processor is further configured to not set the movement prohibited zone when the length of the identified lane branching terrain is above a threshold distance longer than the first distance.

9. A vehicle control device comprising:
a processor configured to
identify a lane merging terrain to be an area which has a first traffic lane, a second traffic lane adjacent to the first traffic lane and a third traffic lane adjacent to the second traffic lane, and is between a first location where the width of the second traffic lane begins to decrease and a second location where the second traffic lane disappears and the first traffic lane and third traffic lane begin to be adjacent, based on map information,
set an area between the first location and a location at a first distance before the second location as a movement prohibited zone where movement of the vehicle between lanes by automatic control is prohibited, when the lane merging terrain has been identified in a predetermined driving zone of a navigation route, and
generate a traveling lane plan representing a traveling lane in which the vehicle is to travel in the predetermined driving zone of the navigation route, based on the current location of the vehicle, the navigation route and the map information,
wherein the processor is further configured to select the traveling so that the vehicle does not move between lanes in the movement prohibited zone.

10. The vehicle control device according to claim 9, wherein the processor is further configured to plan movement of the vehicle between lanes based on surrounding environment information, and
the processor is further configured to set an area between the first location and a location at a second distance that is less than the first distance before the second location, as a control transfer request zone in which the driver is to be given a request to transfer driving of the vehicle from automatic control to manual control, when movement of the vehicle between lanes in the movement prohibited zone has been planned.

11. The vehicle control device according to claim 9, wherein the processor is further configured to plan movement of the vehicle between lanes based on surrounding environment information, and
the processor is further configured to set an area between the first location and a location at a third distance before the first location, as a manual lane change schedule zone in which the driver is to be given a request to move between lanes by manual control, when movement of the vehicle between lanes in the movement prohibited zone has been planned.

12. The vehicle control device according to claim 9, wherein the processor is further configured to not set the movement prohibited zone when the length of the identified lane merging terrain is above a threshold distance longer than the first distance.
